(19) United States
(12) Patent Application Publication
(10) Pub. No.: US 2013/0104543 A1
(43) Pub. Date: May 2, 2013

(54) SUPER-CRITICALLY FUELED DIRECT-INJECTION COMPRESSION IGNITION SYSTEM USING EXHAUST GAS RECIRCULATION

(71) Applicants: Philip Zoldak, Chicago, IL (US); Chris de Boer, Newbury Park, CA (US)

(72) Inventors: Philip Zoldak, Chicago, IL (US); Chris de Boer, Newbury Park, CA (US)

(73) Assignee: Transonic Combustion, LLC, Camarillo, CA (US)

(21) Appl. No.: 13/286,073

(22) Filed: Oct. 31, 2011

(51) Int. Cl. F02M 25/07; F02B 37/00

(52) U.S. Cl. 60/605.2; 123/568.11

(57) ABSTRACT

An exhaust gas recirculation (EGR) system is employed in a supercritically fueled direct-injection compression ignition engine system. The EGR system may include multiple stages, where a portion of exhaust gas is diverted from upstream of a turbine of a turbocharger and a second portion is diverted from downstream of the turbine.

### TECHNICAL FIELD

The present invention relates generally to supercritically fueled direct-injection compression ignition engines, and more particularly, some embodiments relate to exhaust gas recirculation in supercritically fueled direct-injection compression ignition engines.

### DESCRIPTION OF THE RELATED ART

In internal combustion engines, exhaust gas recirculation (EGR) is a nitrogen oxide (NOx) emissions reduction technique. EGR works by recirculating a portion of an engine's exhaust gas back to the engine cylinders. Because NOx forms primarily when a mixture of nitrogen and oxygen is subjected to high temperature, the lower combustion chamber temperatures caused by EGR reduces the amount of NOx the combustion generates.

Various combustion methods have employed cooled EGR for a number of years. Such as diesel compression ignition, or lean burn technologies such as low temperature combustion (LTC) of diesel, homogeneous charge compression ignition (HCCI), partially premixed compression ignition (PCCI) reactivity controlled compression ignition (RCCI) or modulated kinetics (MK). With these methods recirculated exhaust gas is cooled by a coolant, most typically ethylene glycol mixtures commonly found in engine coolant and process water, resulting in heat transfer from EGR to said coolant. Major shortcomings of these technologies have been combustion stability, especially at low loads (less than 5 bar IMEP) with high CO and HCs, operating range limits at high loads due to excessive pressure rise rates.

FIG. 1 is a schematic of a light duty diesel engine system employing EGR. The system includes an engine 104 comprising one or more cylinders 105. An intake manifold 100 is coupled to the cylinders to provide air to the cylinder while a high pressure diesel common rail 114 provides fuel to the cylinder. The fuel and air mix within the cylinder to provide an air/fuel mixture for combustion. Exhaust gas produced by the combustion is expelled from cylinder 105 into exhaust manifold 103. An EGR system is coupled to the exhaust gas manifold. The EGR system includes a valve 106 for controlling the amount of exhaust gas that is recirculated to the engine, a cooler 107 for cooling the exhaust gas, and a line 102 coupled to the intake manifold 100. In the illustrated engine system, the EGR system is upstream of a turbocharger 108. The turbocharger 108 comprises a turbine 109, which uses the exhaust to power a compressor 110. The outlet of the turbine 109 is coupled to the car's exhaust, which may include fuel after treatment systems such as catalytic converters. The inlet of the compressor is coupled to the car's air intake system 113, to provide ambient air into the compressor. A valve 111 may be included to control the amount of air drawn by the compressor. The compressed ambient air is provided to a charge air cooler 101 for cooling the ambient air prior to the intake manifold 100.

### BRIEF SUMMARY OF EMBODIMENTS OF THE INVENTION

According to various embodiments of the invention, an exhaust gas recirculation (EGR) system is employed in a supercritically fueled direct-injection compression ignition engine system. The EGR system may include multiple stages, where a portion of exhaust gas is diverted from upstream of a turbine of a turbocharger and a second portion is diverted from downstream of the turbine.

According to an embodiment of the invention a method, comprises introducing a mixture of exhaust gas and ambient air into an intake manifold of an engine; introducing a volume of air from the intake manifold into a cylinder of the engine; injecting a fuel charge into the cylinder from a fuel injector to provide an air/fuel mixture in the cylinder, the fuel charge being present in the fuel injector as a supercritical fluid prior to injection; and compression igniting the air/fuel mixture.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a schematic of a light duty diesel engine system employing EGR.

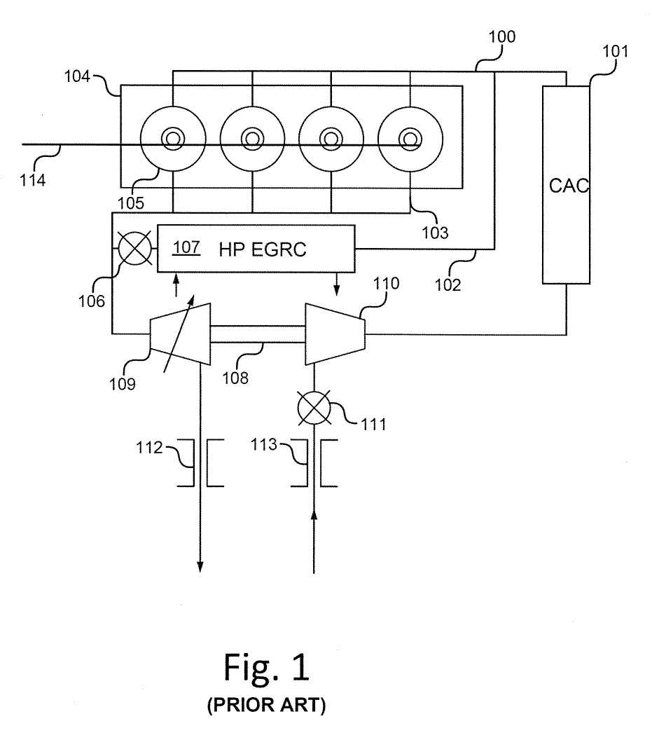

FIG. 2 illustrates an example of a light duty supercritical direct injection CI engine including a single loop high pressure exhaust gas recirculation system (EGR).

FIG. 3 is a schematic of a engine system employing a high pressure and a low pressure exhaust gas recirculation system.

FIG. 4 illustrates an embodiment of the invention employing a two-stage turbocharger.

FIG. 5 illustrates an embodiment employing a two-stage turbocharger and a two stage EGR system.

FIG. 6 illustrates an embodiment of the invention employing two stages of EGR and a super-turbo for air charge compression.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for reducing NOx emissions in a supercritically fueled direct-injection compression ignition engine system. In one embodiment, fuel is direct injected at the supercritical state and mixes rapidly resulting in enhanced mixing and elevated combustion temperatures leading to excessive emissions of oxides of nitrogen and excessive rates of pressure rise. Cooled Exhaust Gas Recirculation (EGR) at levels greater than 20% is used as a method of controlling combustion and the subsequent emissions.

Some embodiments of the invention provide method of reducing emissions and reducing rate-of-pressure-rise and combustion noise in a supercritical fueled CI engine. These methods can include introducing air into a combustion chamber. The air including exhaust gas present at levels greater than 20% by total air mass. Along with the air, the method can include injecting fuel in the supercritical phase. The supercritical phase may be achieved with fuel temperatures greater than 200° C. and fuel pressures greater than 150 bar. In some embodiments the total fuel mass may be injected directly into combustion chamber with single or multiple amounts of fuel, when piston is moving toward cylinder head. The fuel may then be ignited through compression ignition. In some embodiments, the air to fuel ratio is maintained in a range from 14.0:1 to 20.0:1.

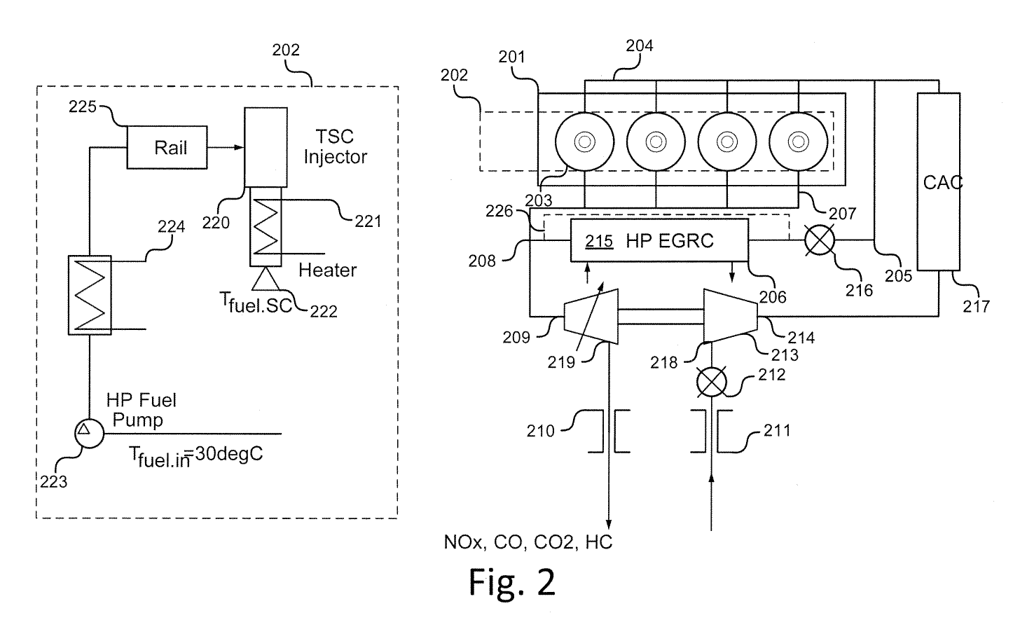

FIG. 2 illustrates an example of a light duty supercritical direct injection CI engine including a single loop high pressure exhaust gas recirculation system (EGR). The system may include an internal combustion engine 201, with dual-loop EGR system 206. The engine 201 comprises four cylinders 203, however it may also include one or more cylinders in other embodiments. In the illustrated embodiment the engine 201 is a four stroke engine. However, in other embodiments, the engines may be two strokes or higher, including all values between two strokes an twelve strokes.

In the illustrated embodiment, a fuel injection system 202 provides fuel to the engine 201. The fuel injection system comprises a fuel injector 220 for each cylinder 203. The fuel injectors are operatively connected, and in fluid communication, with a common fuel rail 225. The common rail 225 maintains the fuel at a predetermined pressure. A fuel pump 223 pumps fuel from a fuel supply to the rail 225. A heater 224 is interposed between the rail 225 and the fuel pump 223, the heater heats the fuel to predetermined temperature. In some embodiments, the temperature and pressure supplied by pump 223 and heater 224 may be at or near supercritical fuel conditions. In further embodiments, the heater may be incorporated into the rail 225 or the pump 223. The heat source for the heather 224 may be either an electrically powered fuel heater or an exhaust gas or EGR gas waste heat recovery fuel heater. In some embodiments, both electric heating and exhaust heat recovery may be employed. Each injector 220 then individually regulate the final supercritical temperature and fuel flow rate provided to each cylinder using a heater 221 and nozzle 222. In some embodiments, the supercritical fuel injection system may be implemented in accordance with U.S. Pat. No. 7,546,826, filed on Mar. 27, 2007, the contents of which are hereby incorporated by reference in their entirety.

The illustrated engine 201 receives air via an intake manifold 204. In various embodiments, the intake manifold 204 may be connected to and in fluid communication with each cylinder 203 through an intake valve or valves (not shown). The intake manifold is further connected to an exhaust gas recirculation (EGR) system 206 and an air intake system.

An exhaust manifold 207 is coupled to and in fluid communication with each cylinder 203 through an exhaust valve or valves (not shown). The exhaust manifold if further connected to the EGR system 206 and an exhaust system. In the illustrated embodiment, a turbocharger is connected to the exhaust system and air intake system. A turbocharger is a turbine 219 and a compressor 213 coupled by a shaft. The exhaust gas passes from the inlet 209 to the exhaust 210, causing the turbine to rotate and power the compressor 213.

In the illustrated embodiment, the inlet 218 of the compressor 213 is coupled to the air intake 211. The compressor compresses the incoming ambient air 211 and forces the compressed air into a charge air cooler (CAC) 217 and intake manifold 204. In further embodiments, the inlet 218 may also be connected to the EGR system 206. For example, some of the air from the outlet of the turbine 219 may be introduced into the inlet 218 of the compressor 213. A valve or valves 212 may control the rate of air passing through the compressor 213. In some embodiments, a variable geometry turbocharger may be employed. A variable geometry turbocharger allows one or more parameters of the turbocharger, e.g., turbine vane angle, to be varied. This variable geometry allows relatively more uniform compressor output over a range of engine speeds. This relatively more uniform output may be accomplished by maintaining a relatively uniform turbine, shaft and compressor rotational speed.

The EGR system 206 comprises a line 208 coupling the system 206 to the exhaust system. In the illustrated embodiment, EGR system 206 is coupled to the exhaust system upstream of the turbine 219. The EGR system further comprises a cooler 215, configured to cool the exhaust gas before it is provided to the intake manifold 204. In some embodiments, the cooler 215 may employ coolant. In other embodiments, the cooler 215 may comprise a heat exchanger where heat from the exhaust gas is used to heat the fuel used in the fuel injection system 202. In still further embodiments, hybrid heat exchanger and coolant systems may be employed. A valve or valves 216 may be placed upstream or down stream of the cooler 215 to control the amount of exhaust gas recirculated into the intake manifold 204. The EGR system 206 further comprises a line 205 coupling the cooler 206 to the intake manifold 204.

In particular embodiments, copious amounts of exhaust gas are recirculated into the intake manifold 204. For example, in one embodiment between 20%-40% of the total air mass provided to the engine 201 by the manifold 204 comprises exhaust gas. Such amounts may enable the engine to achieve NOx emission targets as well as manage rates of combustion pressure rise across the engine load range.

Additionally, EGR system 206 may include a bypass valve (not pictured) to couple system to an alternate channel 226. The alternate channel 226 bypasses the cooler 215, or one or more stages of a multi-stage cooler. A valve or valves (not picture) may regulate the flow of exhaust gas delivered the cooler 215 and alternate channel 226, allowing control of temperature of the recirculated exhaust gas in addition to total amount.

In various embodiments, the engine displacement may be between 1 liter to 15 L. Engine displacement may be understood as the total volume of air or air/fuel mixture an engine can draw in during one cycle by all of the cylinders, or may be understood as the volume swept by the pistons as the piston top is moved from top dead center (TDC) (i.e., the top of the cylinder) to bottom dead center (BDC) (i.e., the bottom of the cylinder). In some embodiments, the engine 201 may have a compression ratio between 12:1 to 20:1. The compression ratio may be understood as the change in volume of the combustion chamber when the piston is at the top dead center VTDC and the bottom dead center VBDC.

In various embodiments, the fuel injection system 202 injects fuel charges into the engine cylinders 203 using direct fuel injection. In particular embodiment, the fuel charges are in the supercritical state, at least immediately prior to injection. A super-critically fueled direct-injection charge may be developed by varying the injector fuel pressure and fuel temperature such that the fuel is injected in the supercritical phase prior to injection. The supercritical fuel is injected into the cylinder and may remain in the supercritical phase during the injection and mixing into the cylinder or may change phase to liquid depending on temperature, and pressure of cylinder charge and injection timing. In some embodiments, portions of the fuel charge may stay remain in the supercritical phase while other portions may change phase to liquid.

In additional embodiments, super-critically fueled direct-injection systems 202 may provide a charge that varies in stratification (e.g., partially premixed and partially stratified supercritical) depending on operating conditions. In stratified charges, the air/fuel mixture may be layered. For example, a rich supercritical spray jet may be directed outwards from the injector nozzle and towards the outer regions of the piston and cylinder and may begin to mix rapidly with fresh air or a mixture of fresh air and EGR creating a ignitable mixture that has an overall lean air fuel ratio or may also be close to overall stoichiometric air fuel ratio. The fuel air mixture may auto-ignite in regions where locally stoichiometric air fuel ratios are present and sufficient compression temperature is achieved. Combustion may initiate in these well mixed regions and propagate to other regions of the cylinder where local fuel air mixture is lean. Combustion may also initiate in regions surrounding the fuel spray jet and may propagate towards other regions of well mixed air and fuel igniting some areas that are relatively lean or rich surrounding the fuel spray jet.

In various embodiments, the supercritical injector 220 may be located in the centerline of the combustion chamber or may be located offset to the centerline of the combustion chamber. Alternatively, the injector 220 or may be located off to the side and be configured to inject the fuel charge at some angle towards the center of the combustion chamber. For example, the system 202 may include a wall directed combustion system, where fuel may be injected into the combustion chamber from the side and deflected by a recess in the piston bowl towards the center.

Additionally, a multiple injection strategy may be used in some embodiments to develop a stratified supercritical charge. In these embodiments, portions of the total fuel charge are injected in at least two stages. In some embodiments, the first, or early, portion or portions of fuel are injected between −170° to −30° after TDC (ATDC) to create a premixed supercritical fuel charge. The second, or main, portion of supercritical fuel is injected closer to TDC, for example between −30° and 0° ATDC. In still further embodiments, a late injection strategy may also be employed where the late injection occurs anywhere between Oto 30° ATDC.

In embodiments employing a multiple injection strategy, the first portion of fuel may be in the range of 1% to 50% of the total fuel mass injected for a given lean air fuel ratio charge. As noted above, the injector 220 may be a high pressure injector, wherein the fuel may be at a pressure of 100 bar or greater, including all values and increments in the range of 100 bar to 600 bar. The first portion of fuel may mix with the incoming charge of air as the piston begins to extend towards TDC.

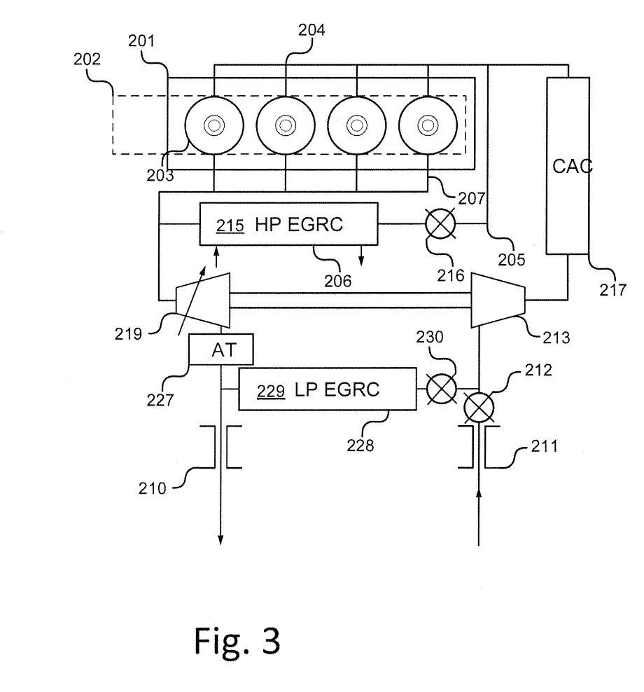

In some embodiments, the exhaust gas recirculation system may comprise a high pressure exhaust gas recirculation system and a low pressure exhaust gas recirculation system. FIG. 3 is a schematic of a engine system employing a high pressure and a low pressure exhaust gas recirculation system. In this illustration, like reference numbers refer to like components illustrated in FIG. 2. With respect to FIG. 3, the exhaust gas recirculation system 206, will be referred to as a high pressure exhaust gas recirculation system (HP EGR). The illustrated embodiment further comprises a low pressure exhaust gas recirculation system (LP EGR). The LP EGR system 228 comprises tubing coupling the exhaust gas emitted from the outlet of the turbine 219 to the inlet of the compressor 213. This exhaust gas may be cooled in a cooler 229. In some embodiment, the cooler 229 may employ coolant, or may comprise a second stage of a heat exchanger for heating the fuel charge. A valve 230 allows control of the amount of low pressure exhaust gas provided to the inlet of compressor 213. A portion of the exhaust may be diverted into the LP-EGR system and a portion may leave the system through the exhaust piping.

Additionally, an exhaust after treatment system 227 may be provided upstream of the LP EGR system. The exhaust after-treatment device 227 is a device which reduces or oxides engine-out emissions via some type of catalyst substrate. For example, the exhaust after-treatment device may include a three-way catalytic converter system, an oxidation catalyst, a lean NOx trap, or an SCR system. The exhaust after-treatment device may be understood as a system which may reduce nitrous oxides (NOx) into N₂ and xO₂; oxidize carbon monoxide (CO) into (CO₂); and oxidize unburned hydrocarbons (HC) into carbon dioxide (CO₂) and water (H₂O).

As discussed above, the air provided by the intake manifold 204 to the engine 201 includes ambient air drawn in through the compressor inlet piping and also exhaust gas air directed through the HP-EGR system or LP-EGR system. The exhaust gas air may be present at levels greater than 20% by mass of the intake air. The exhaust gas may be low pressure exhaust gas, high pressure exhaust gas, or a mixture thereof, depending upon the load and temperature of the engine. For example, at low loads, e.g., less than IMEP of 5 bar, or during cold start, e.g., when the coolant temperature is below 120° F., the exhaust gas may include mostly high pressure exhaust gas provided at a relatively high temperature. The high pressure exhaust gas may be present at 0 to 55% by exhaust gas air mass, including all values and increments therein. At higher loads, e.g., IMEP of 5 bar or greater, or higher temperatures, e.g., when the coolant temperature is above 120° F., the exhaust gas may include mostly low pressure exhaust gas. The low pressure exhaust gas may be present at greater than 50% by exhaust gas air mass.

In the illustrated embodiment, the air and/or EGR gases provided to the intake manifold by the HP-EGR system 206 and LP-EGR system 228 may be quite different. The HP-EGR loop 206 receives EGR gas directly from the exhaust manifold 207. Accordingly, this EGR gas may contain relatively hot unburned fuel and air or relatively hot unfiltered EGR gas that may include NOx, CO or HC. This air or EGR gas may or may not pass through an HP EGR cooler prior to being provided to the intake manifold.

On the other hand, the LP-EGR system 228 receives EGR gas that has passed through the turbine 219 (and done work), and that, in some embodiments, has been filtered by the exhaust after-treatment system 227 (e.g. an oxidation catalyst). The filtered EGR gas passes through LP-EGR cooler 228 and LP-EGR valve 230 and to mix with ambient air 211 in the inlet of compressor 213. The mixture of ambient air and filtered EGR gas is then compressed in the turbocharger compressor 213. In some embodiments, the compressed air and/or filtered EGR gas may then pass through an interstage cooler and may then pass through an HP turbocharger compressor. The compressed air and/or filtered EGR gas may then pass through an intercooler 217. The compressed and cooled air and/or filtered EGR gas may be regulated by intake throttle and may then be provided to the intake manifold 204. Accordingly, this air and/or filtered EGR gas may contain a relatively larger fraction of ambient air and a relatively smaller fraction of exhaust gas than the EGR gas provided by the HP-EGR system 206.

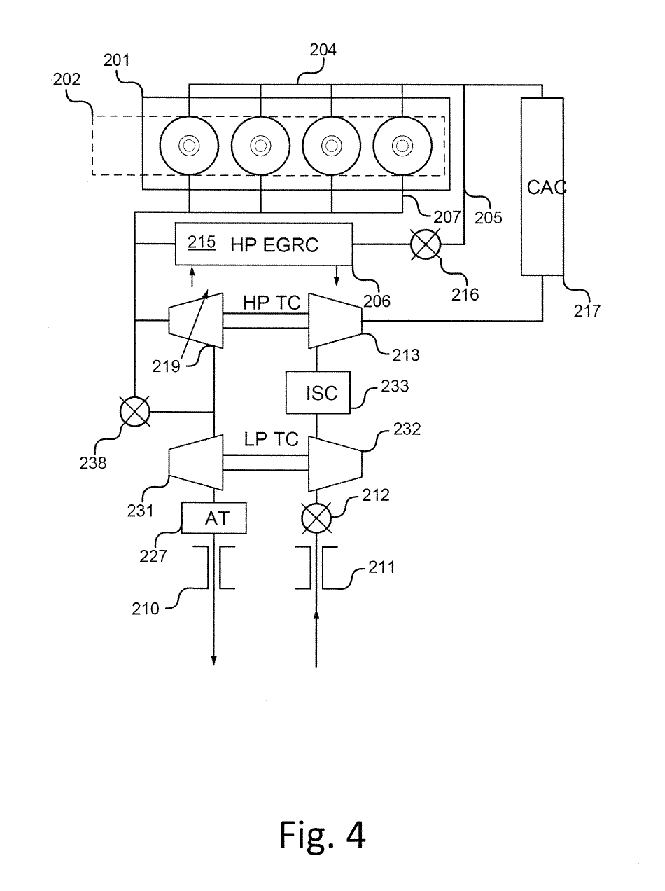

FIG. 4 illustrates an embodiment of the invention employing a two-stage turbocharger. In this embodiments, the outlet of the turbine 219 is coupled to the inlet of the turbine 231 of a second turbocharger. Similarly, the outlet of the compressor 232 of the second turbocharger is coupled to the inlet of the compressor 213 of the first turbocharger. The two-stage turbocharger may also include an intercooler 233 between the low pressure and high pressure compressor stages. A bypass valve 238 may be used to divert exhaust gas away from the HP stage 219 to the LP stage 231 and may be used during engine conditions where high flow is desired. An alternative embodiment may include a waste gate valve (not pictured).

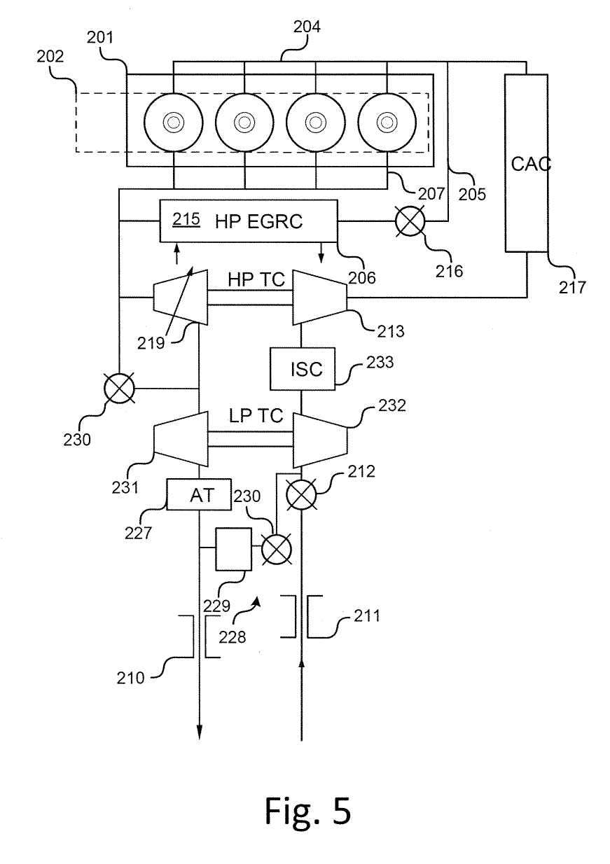

Some embodiments may employ a two-stage turbocharger and a two-stage EGR system. FIG. 5 illustrates such an embodiment. In this embodiment, the LP EGR system 228 is coupled downstream of the turbine 231 of the second turbocharger and upstream of the compressor 232 of the second turbocharger. Various other arrangements may be implemented, for example, the HP EGR or LP EGR system, or even a third EGR system, may be interposed between first turbocharger and the second turbocharger to divert exhaust gas from the turbine 219 into the compressor 213.

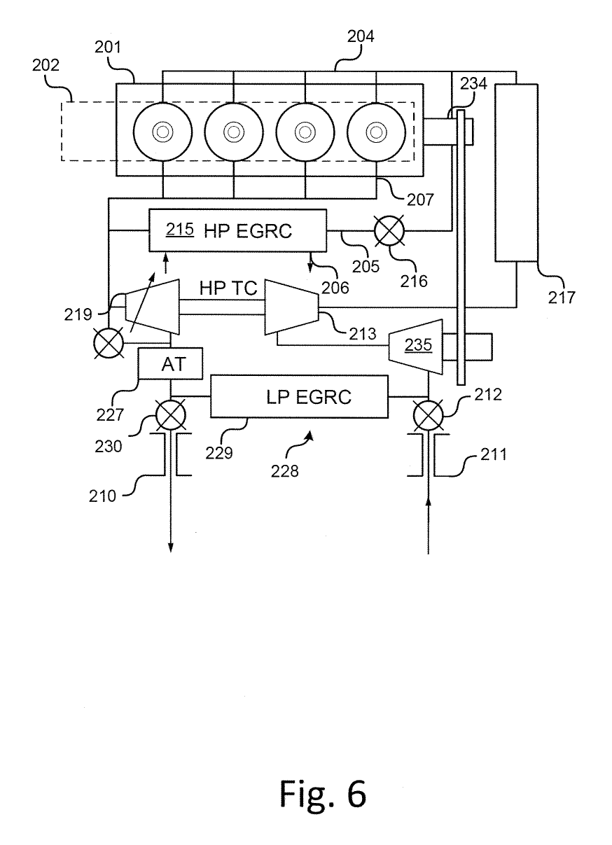

In further embodiments, a super charger may also compress the intake air. FIG. 6 illustrates an embodiment of the invention employing two stages of EGR and a super-turbo for air charge compression. In the illustrated embodiment, the supercharger 235 is used in place of the LP turbocharger of the embodiment illustrated in FIG. 5. The supercharger comprises a compressor 235 driven by the crankshaft 234 of the engine 201. The outlet of the supercharger's compressor 235 is couple to the inlet of the high pressure turbocharger's compressor 213. In this embodiment, the low pressure EGR system is coupled to the inlet of the compressor 235. In various other embodiments, a supercharger may be used either as a stand-alone device in place of the turbocharger or may also be used in place of the HP turbocharger in the two-stage embodiment.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, comprising:
introducing a mixture of exhaust gas and ambient air into an intake manifold of an engine;
introducing a volume of air from the intake manifold into a cylinder of the engine;
injecting a fuel charge into the cylinder from a fuel injector to provide an air/fuel mixture in the cylinder, the fuel charge being present in the fuel injector as a supercritical fluid prior to injection; and
compression igniting the air/fuel mixture.

2. The method of claim 1, wherein the step of introducing a mixture of exhaust gas and ambient air into the intake manifold comprises diverting exhaust gas from upstream of an exhaust gas treatment system into the intake manifold.

3. The method of claim 2, further comprising cooling the exhaust gas prior to introducing the exhaust gas into the intake manifold.

4. The method of claim 1, wherein the step of introducing a mixture of exhaust gas and ambient air into the intake manifold comprises diverting exhaust gas from downstream of an outlet of a turbine of a turbocharger into the intake manifold.

5. The method of claim 4, further comprising cooling the exhaust gas prior to introducing the exhaust gas into the intake manifold.

6. The method of claim 4, wherein the step of diverting exhaust gas from downstream of the outlet into the intake manifold comprises providing the exhaust gas diverted from downstream of the outlet into an inlet of a compressor of the turbocharger.

7. The method of claim 1, wherein the step of introducing a mixture of exhaust gas and ambient air into the intake manifold comprises:
diverting a first portion of exhaust gas from upstream of an exhaust gas treatment system into the intake manifold; and
diverting a second portion of exhaust gas from downstream of an outlet of a turbine of a turbocharger into the intake manifold.

8. The method of claim 1, wherein the step of injecting the fuel charge into the cylinder comprises injecting the fuel charge during a compression stroke of a piston disposed in the cylinder.

9. The method of claim 1, wherein the step of injecting the fuel charge into the cylinder comprises injecting a first portion of the fuel charge during an intake stroke of a piston disposed in the cylinder and injecting a second portion of the fuel charge during a compression stroke of the piston.

10. The method of claim 1, wherein the mixture of exhaust gas and ambient air comprises between 20% and 40% exhaust gas.

11. An engine system, comprising:
an intake manifold in fluid communication with a cylinder of an engine to provide a volume of air into the cylinder;
an exhaust system in fluid communication with the cylinder to receive exhaust from the cylinder;
an exhaust gas recirculation system in fluid communication with the exhaust system and in fluid communication with the intake manifold to provide a mixture of exhaust gas and ambient air in the intake manifold; and
a fuel injector configured to inject a fuel charge into the cylinder to create an air/fuel mixture for compression ignition, the fuel injector comprising a heater and a fuel chamber configured to maintain a fuel charge as a supercritical fluid prior to injection of the fuel charge into the cylinder.

12. The system of claim 11, wherein the exhaust gas recirculation system is coupled to the exhaust system upstream of an exhaust gas treatment system.

13. The system of claim 12, wherein the exhaust gas recirculation system comprises a cooling system to cool the exhaust gas prior to introducing the exhaust gas into the intake manifold.

14. The system of claim 11, wherein the exhaust gas recirculation system is coupled to the exhaust system downstream of an outlet of a turbine of a turbocharger

15. The system of claim 14, wherein the exhaust gas recirculation system comprises a cooling system to cool the exhaust gas prior to introducing the exhaust gas into the intake manifold.

16. The system of claim 14, wherein the exhaust gas recirculation system is coupled downstream of the outlet and upstream of the inlet of a compressor of the turbocharger.

17. The system of claim 11, wherein the exhaust gas recirculation system comprises:
a high pressure exhaust gas recirculation system coupled to the exhaust system upstream of an exhaust gas treatment system; and
a low pressure exhaust gas recirculation system coupled downstream of an outlet of a turbine of a turbocharger.

18. The system of claim 11, wherein the fuel injector is coupled to an engine control unit configured to cause the fuel injector to inject the fuel charge during a compression stroke of a piston disposed in the cylinder.

19. The system of claim 11, wherein the fuel injector is coupled to an engine control unit configured to cause the fuel injector to inject a first portion of the fuel charge during an intake stroke of a piston disposed in the cylinder and inject a second portion of the fuel charge during a compression stroke of the piston.

20. The system of claim 11, wherein the mixture of exhaust gas and ambient air comprises between 20% and 40% exhaust gas.
